(19) United States
(12) Patent Application Publication
(10) Pub. No.: US 2013/0331160 A1
(43) Pub. Date: Dec. 12, 2013

(54) GAME MACHINE

(71) Applicant: Konami Digital Entertainment Co., Ltd., Tokyo (JP)

(72) Inventors: Kenta Ito, Minato-ku (JP); Tetsuo Ishida, Minato-ku (JP); Nobuyasu Tamura, Minato-ku (JP)

(73) Assignee: Konami Digital Entertainment Co., Ltd., Tokyo (JP)

(21) Appl. No.: 13/905,835

(22) Filed: May 30, 2013

(30) Foreign Application Priority Data
Jun. 6, 2012 (JP) 2012-128963

(51) Int. Cl. A63F 13/00

(52) U.S. Cl. CPC A63F 13/00
USPC 463/6

(57) ABSTRACT

A game machine comprises: a chasses having a top plate and a section plate arranged at a lower surface side of the top plate to make space; a traveling body arranged in the space and capable of traveling along an upper surface of the section plate; and a sensor outputting signal corresponding to a position of the traveling body, the sensor having a flexible sheet-like detection portion that is laid on the section plate and a substrate portion being provided with an electric circuit component for detecting the position using the detection portion and connected with an end portion of the detection portion. In the game machine, the end portion of the detection portion of the sensor is bent along a side surface of the chassis from a circumferential edge portion of the section plate, and the substrate portion is attached to the chassis at the side surface.

### CROSS REFERENCE TO RELATED APPLICATION

This application claims priority to Japanese Patent Application No. 2012-128963, filed Jun. 6, 2012, the disclosure of which is hereby incorporated by reference in its entirety.

### TECHNICAL FIELD

The present invention relates to a game machine where a traveling body is arranged at a lower surface side of a top plate, and a game using travel of the travelling body is provided to a player.

### BACKGROUND ART

There is known a game machine configured so that a field is provided at an upper surface side of a top plate of its chassis, a plurality of models representing racehorses and the like are arranged on the field, a section plate is provided below the top plate of the chassis to make space, a plurality of traveling bodies capable of self-propelling are arranged within the space, and by coupling the traveling body and the model with each other through the top plate by magnetic force, the model can travel following the traveling body. For this type of game machine, it is necessary to sequentially detect the position of traveling body in order to control the travel of traveling body. In order to solve this problem, suggested is a game machine using an electromagnetic coupling type of sensor to detect the position of traveling body, the sensor being configured in such a way that a sheet-like detection portion where transmitting-side coils and receiving-side coils are arranged so as to be perpendicular to each other, is laid on all over the travel surface of the traveling body, and used is change of electromagnetic coupling between the coils, the change being provoked by approach of an electronic conductor, such as metal piece, provided to the traveling body to the coils (for example, the Patent Literature 1).
Patent Literature PTL1: JP-A-2011-188906.

### SUMMARY OF INVENTION

### Technical Problem

In a case of the sensor above mentioned, a substrate portion having an electric circuit component for detecting a state of electromagnetic coupling is generally connected to an end portion of the detection portion. The substrate portion is much thicker than the detection portion. Therefore, in a case that the substrate portion is positioned at the circumferential edge portion of the section plate, the space between the top plate and the travel surface is narrowed by the substrate portion. Further, since the substrate portion itself is concealed below the top plate, it is hard to access to the substrate portion. Thereby, there is a possibility to occur some obstacles in various kinds of works such as maintenance of the traveling body.

Then, the aim of the present invention is providing a game machine capable of improving workability of the maintenance or the like by ameliorating installation structure of a sensor having a sheet-like detection portion.

### Solution to Problem

A game machine as one aspect of the present invention is a game machine comprising: a chasses having a top plate and a section plate arranged at a lower surface side of the top plate to make space; a traveling body arranged in the space and capable of traveling along an upper surface of the section plate; and a sensor outputting signal corresponding to a position of the traveling body, the sensor having a detection portion that is laid on the upper surface of the section plate and has a flexibility and a sheet shape and a substrate portion being provided with an electric circuit component necessary for detecting the position using the detection portion and connected with an end portion of the detection portion, wherein the end portion of the detection portion of the sensor is bent along a side surface of the chassis from a circumferential edge portion of the section plate, and the substrate portion is attached to the chassis at the side surface.

According to the game machine of the present invention, the detection portion of sensor is bent at the circumferential edge portion of the section plate and the substrate portion is attached to the chassis to the side surface of the chassis. Accordingly, the space between the top plate and the section plate is never narrowed. Therefore, the substrate portion is not an obstacle to a work such as taking in and out of the traveling body. Further, since the substrate portion is not concealed below the top plate, but positioned on the side surface of the chassis, it is possible to access to the substrate portion easily. Therefore, it is possible to enhance workability of maintenance of the game machine and the like.

In one embodiment of the present invention, a guiding member an outer circumference of which is rounded may be attached to a border between the circumferential edge portion of the section plate and the side surface of the chassis, and the detection portion may be bent so as to wrap the guiding member. Thereby, it is possible to bend the end portion of the detection portion easily, and avoid a possibility that the detection portion is damaged by a corner of the section plate or the like.

A position where the substrate portion is attached to the chasses may be capable of been adjusted in a vertical direction. By adjusting the position of the substrate portion, it is possible to lay the detection portion on the section plate with an appropriate force.

Further, the substrate portion may be attached to the chassis through an attachment member, a position where the attachment position is attached may be capable of being adjusted in the vertical direction, and the attachment member may be coupled with the end portion of the detection portion through a subsidiary member. Thereby, when downward force is applied to the attachment member, as the force is transferred to the detection portion through the subsidiary member, there is no possibility that a force to separate the substrate portion from the detection portion is applied to between the substrate portion and the detection portion. Accordingly, it is possible to avoid a trouble such as detachment, separation, and disconnection, which could occur between the substrate portion and the detection portion due to overload at the moment when the substrate portion is attached.

The sensor may be configured in such a way that a plurality of modules are aligned side-by-side on the upper surface of the section plate, and each of the plurality of modules may be provided with the detection portion and the substrate portion. In this case, the substrate portion exists for each module. Therefore, it is possible to perform significantly the effect brought by arranging the substrate portion at the side surface of the chassis.

A plurality of station units, each of which allows a player to play a game, may be arranged around the chasses in separable state from the chassis, and the position where the substrate portion is attached to the chassis may be set in a region covered by the station units. In this case, by separating the stations from the chassis, it is possible to access to the position where the substrate portion is attached. Accordingly, it is possible to expose the substrate portion more easily than before.

### Effects of Invention

As mentioned above, according to the game machine of the present invention, since the detection portion of the sensor is bent at the circumferential edge portion of the section plate and the substrate portion is attached to the chassis at the side surface of the chassis, the space between the top plate and the section plate is not narrowed due to the substrate portion, and the substrate portion is not concealed below the top plate. Therefore, it is possible to enhance workability at the moment of maintenance of the game machine or the like.

### BRIEF DESCRIPTION OF DRAWINGS

FIG. 1 is a perspective view showing an external appearance of a game machine according to one embodiment of the present invention.

FIG. 2 is a perspective view showing a state that major portions of a filed unit and a monitor unit are shown by removing the station units from the game machine.

FIG. 3 is a perspective view showing a major portion of a chassis.

FIG. 4 is a perspective view showing an internal construction of the chassis.

FIG. 5 is a diagram showing an example of model and self-propelling vehicle.

FIG. 6 is a perspective view showing an outline construction of a sensor provided on a travel surface of the self-propelling vehicle.

FIG. 7 is a diagram showing installation structure of the sensor.

FIG. 8 is a diagram showing expanded major portion of FIG. 7.

FIG. 9 is a partial vertical sectional view showing a positional relation between the chassis of the game machine and the station unit.

FIG. 10 is a diagram for explaining an outline of procedures of generating the correction data of sensor.

FIG. 11 is a functional block diagram showing mainly a portion of a control system of game machine, the portion relating to the generation of correction data.

FIG. 12 is a flowchart showing procedures of correction data generating process implemented by the correction data generating portion shown in FIG. 11.

FIG. 13 is a flowchart showing a variation of the flowchart shown in FIG. 12.

### DESCRIPTION OF EMBODIMENTS

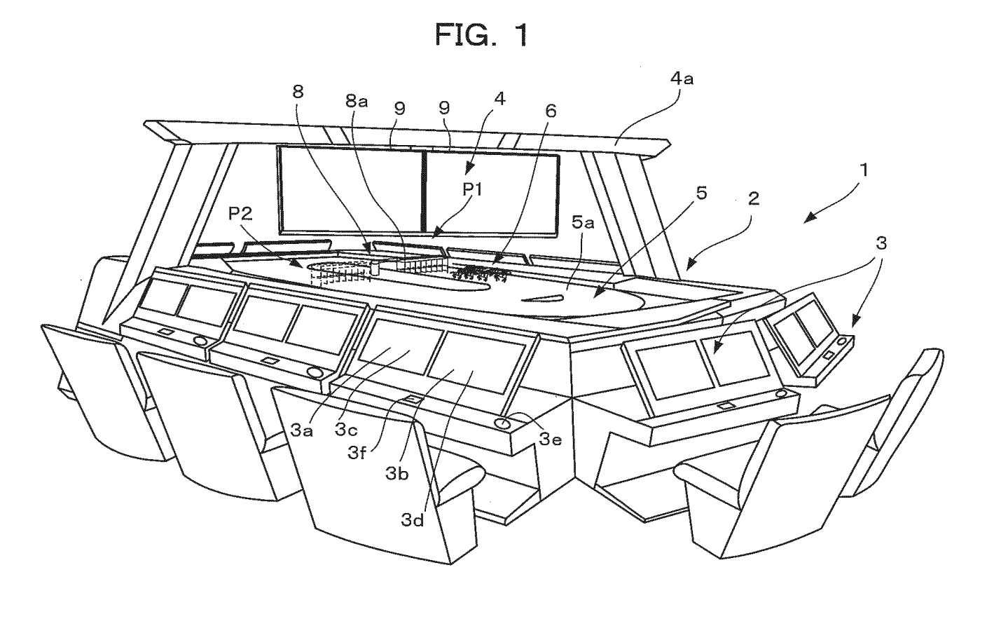

FIG. 1 shows an overall view of a game machine according to one embodiment of the present invention. The game machine 1 is configured as a game machine for commercial use (business use) which is installed to a facility such as a store, and allows a player, in exchange of payment of a game-play fee, to play a game in a range corresponding to the game-play fee. The game machine 1 is a so-called medal game machine using medals as game media.

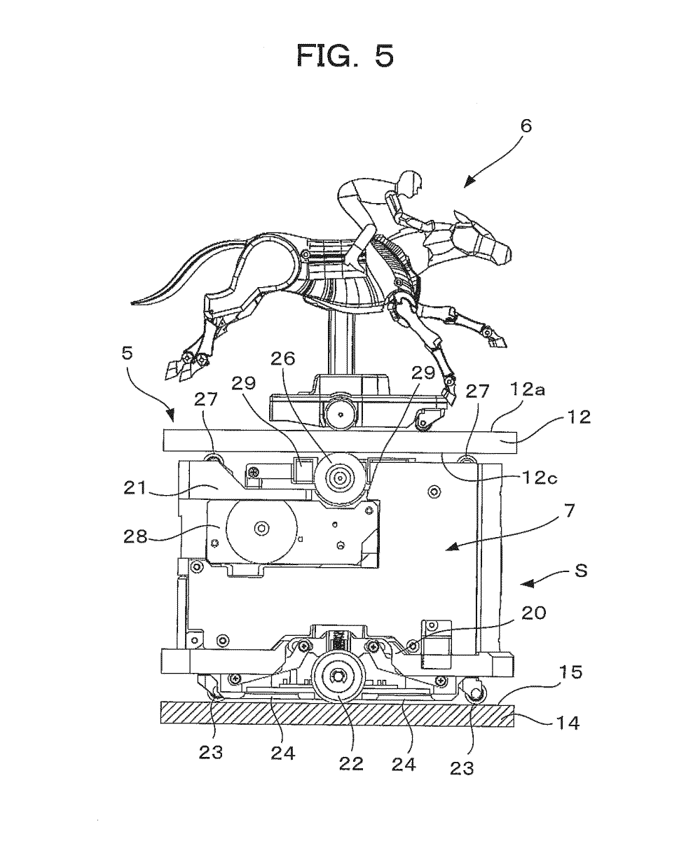

The game machine 1 comprises: a field unit 2; a plurality of station units 3 arranged so as to surround the field unit 2; and a monitor unit 4 arranged so as to be adjacent to the field unit 2. A field 5 is provided at an upper surface side of the field unit 2. In the field 5, played is a race horse game where each of plural models 6 representing racehorses is made to run within an oval-shaped course 5a to compete for its arrival order. As shown in FIG. 5 as one example, the model 6 is coupled by electromagnetic power with a self-propelling vehicle (a traveling body) 7 capable of traveling on a travel surface 15 provided to the inside of the field unit 2. Thereby, the model 6 travels on the field 5 following the self-propelling vehicle 7. The details of self-propelling vehicle 7 will be described later. A center portion of the field 5 is provided with a gate unit 8. The gate unit 8 has a gate 8a to align the models 6 before a race. The gate 8a can move selectably to one of the following positions: a position which is housed in the center of the field 5, a position P1 which intersects the course 5a in one side of the field 5, and a position P2 which interests the course 5a in the other side of the field 5.

The station unit 3 is provided as a terminal apparatus for allowing a player to participate in the game executed in the field 5. The station unit 3 is provided with a first monitor 3a and a second monitor 3b; and a first touch panel 3c and a second touch panel 3d which are transparent and overlapped on the surfaces of the first monitor 3a and the second monitor 3b respectively, a medal input slot 3e which accepts input of medals, and a card reader 3f which reads a card (not illustrated) possessed by a player to output a signal corresponding to the information read out of the card. At each station unit 3, one or two players can play the game. Each of the touch panels 3c, 3d is a known input device that outputs the signal depending on a position touched by a player with his/her finger. When some medals are input into the medal input slot 3e, the medals input are converted into credits which can be used in the hose race game. The credits are expended and paid out depending on the game content. The card read by the card reader 3f is provided with a non-volatility memory medium (not illustrated) such as an IC chip and a magnetic stripe. In the medium, an ID unique for each card (hereinafter, sometimes referred to as “the card ID”) is recorded. Incidentally, the card ID may be recorded to a card in form of a bar code or the like. Alternatively, in exchange of a card, the card ID may be recorded in the memory medium such as an IC chip mounted in a portable phone or the like.

The monitor unit 4 comprises a plurality of main monitors 9 for displaying information relating to the game (including image and the like). Though FIG. 1 shows a state that two main monitors 9 are aligned side-by-side, behind the main monitors 9, also arranged are two main monitors 9 in such a way that the display surfaces thereof face the opposite direction. The main monitors 9 are supported in a hanging state so as to pass over the field 5 obliquely to the longitudinal direction of the field 5. As the main monitor 9, a substantially plate-like flat panel display, such as a liquid crystal display, a plasma display, and an organic EL display is employed.

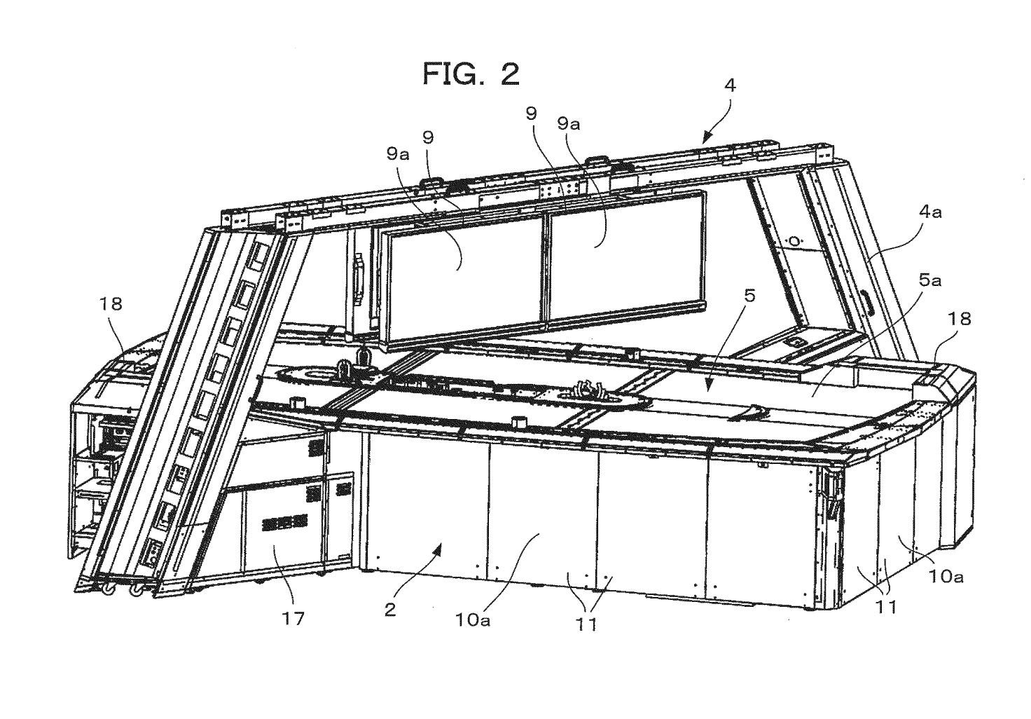

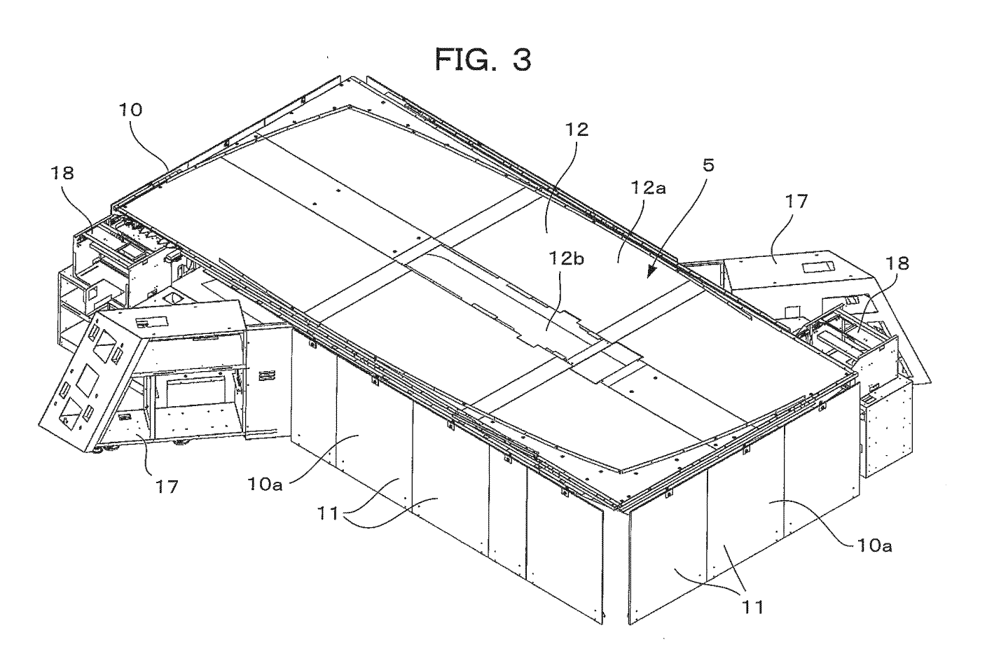

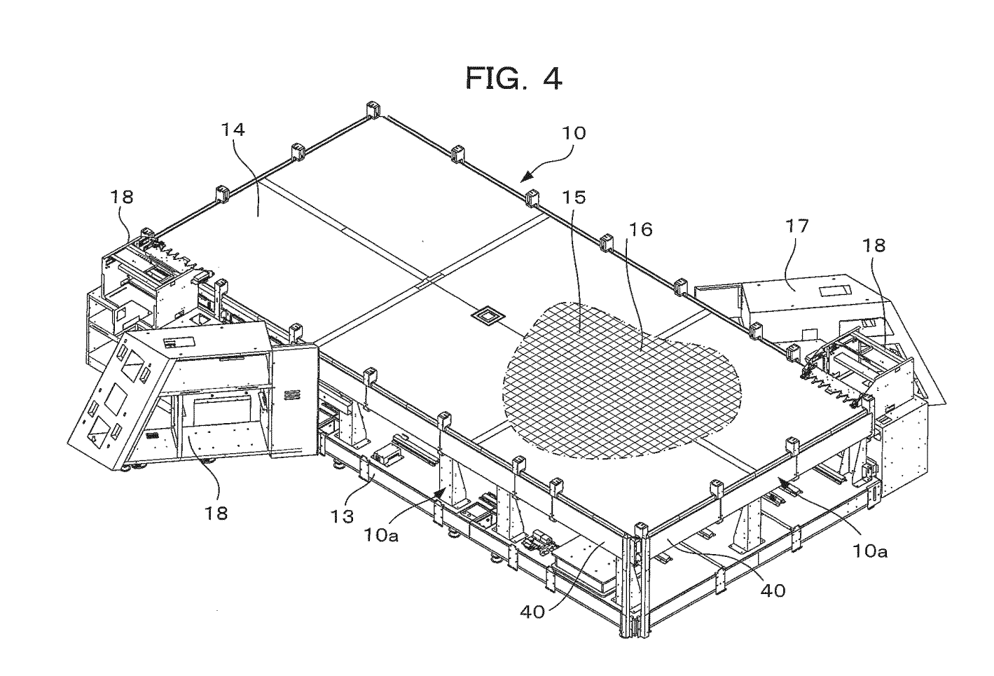

FIG. 2 shows a state that major portions of the filed unit 2 and the monitor unit 4 are shown by removing the station units 3 from the game machine 1. The field unit 2 has a chassis 10 as a major structure thereof. FIG. 3 shows a major portion of the chassis 10 in a state that a decorative panel and the other accessories are removed from the chassis 10. As apparent by FIGS. 2 and 3, the chassis 10 has a box-shaped structure which is a substantially cuboid, the side surfaces 10a of which are covered by side plates 11 respectively and the upper surface side of which is covered by a top plate 12. The field 5 is formed on the upper surface 12a of the top plate 12. In the top plate 12, formed is an opening portion 12b for housing the gate unit 8 (see, FIG. 3). FIG. 4 shows a state that the side plates 11 and the top plate 12 are removed from the chassis 10. Inside of the chassis 10, provided is a frame 13 constituting a frame of the chassis 10. The upper portion of the frame 13 is provided with a plate-like section plate 14. The section plate 14 is installed below the top plate 12 in parallel to the top plate 12. The upper surface of the section plate 14 is configured as the travel surface 15 of the self-propelling vehicle 7. The travel surface 15 is parallel to the upper surface 12a of the top plate 12 (see FIG. 5). A sensor 16 for detecting the position of the self-propelling vehicle 7 is provided to all over the travel surface 15. The details of the sensor 16 will be described later. Incidentally, in the outer circumference of the chassis 10, provided are a base 17 of the monitor support frame 4a and an electric charge unit 18 for charging up the self-propelling vehicle 7.

As shown in FIG. 5, the self-propelling vehicle 7 is disposed in space S existing between the travel surface 15 and the lower surface 12c of the top plate 12. The self-propelling vehicle 7 comprises a lower vehicle platform 20 and an upper vehicle platform 21. The lower vehicle platform 20 has a pair of left and right wheels 22 (only one side of them is shown in FIG. 5) contacting the travel surface 15, and rear and front supplementary wheels 23. As the lower vehicle platform 20 does not have a drive source, the wheels 22 and the supplementary wheels 23 are non derive wheels. Detected pieces 24 are provided at the backward and forward of the wheels 22 respectively. Each detected piece 24 is an object which is made of electric conductor such as metal, and should be detected by the sensor 16. For discriminating each of the front side and rear side of the self-propelling vehicle 7, the front detected piece 24 and the rear detected piece 24 may be different from each other in the size or the shape.

On the other hand, the upper vehicle platform 21 comprises a pair of left and right wheels 26 (only one side of them is shown in FIG. 5), rear and front supplementary wheels 27 and a drive unit 28 driving to rotate the wheels 26, the pair of wheels 26 contacting the lower surface 12c of the top plate 12 so as to be pressed to the lower surface 12c by a not-illustrated press mechanism built in between the vehicle platforms 20, 21. The wheels 26 are the drive wheels of the self-propelling vehicle 7. The drive unit 28 is configured so as to change as appropriate traveling direction and traveling speed, for example, by driving each of the pair of wheels 26 independently. Magnets 29 are provided at the backward and forward of the wheels 26 respectively. Those magnets 29 draw not-illustrated magnets or strong magnetic bodies built in a carriage 6a of the model 6. Thereby, the self-propelling vehicle 7 and the model 6 are coupled with each other through the top plate 12. Incidentally, though the sensor 16 is not illustrated in FIG. 5, all over of the travel surface 15 is covered by the detection portions of the sensor 16 actually.

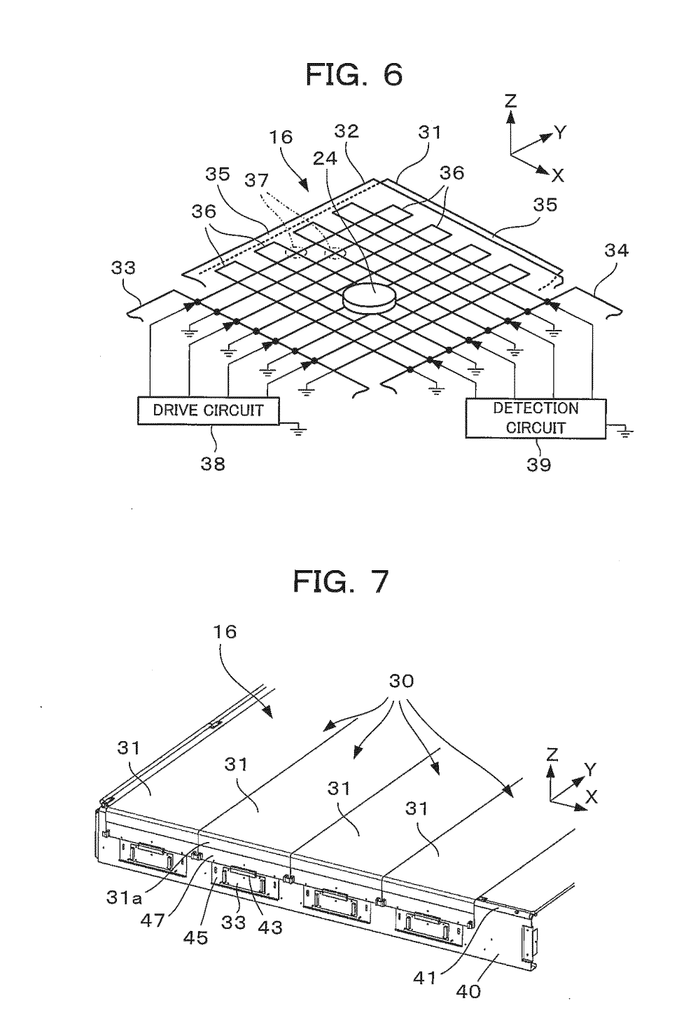

Next, the details of the sensor 16 will be described. As shown in FIG. 6, a pair of sheet-like detection portions 31, 32 and substrate portions 33, 34 combined with the detection portions 31, 32 respectively. Each of the detection portions 31, 32 has a construction that a lot of loop-like coils 36 are embedded in a base sheet 35 made of dielectric material, the coils being parallel to each other and arranged at constant intervals. The base sheet 35 is made of resin, and the coil 36 is formed by folding back parallelly a conductor line having a small wire diameter. Thereby, each of the detection portions 31, 32 has bendable flexibility. When it is defined that X direction is the longitudinal direction of the travel surface 15 of the chassis 10, Z direction is a direction perpendicular to the travel surface 15, and Y direction is perpendicular to both of the X and Z directions, one detection portion 31 is provided on the travel surface 15 so that the coils 36 of the detection portion 31 are aligned in the X direction, and the other detection portion 32 is overlapped on the one detection portion 31 so that the coils 36 of the detection portion 32 are aligned in the Y direction. Thereby, the coils 36 of the one detection portion 31 and the coils 36 of the other detection portion 32 are arranged so as to be perpendicular to each other, and at the intersection portion of them a cell portion 37 is formed. The gate unit 8 is hosed in the space S through the opening portion 12b of the top plate 12, and the portion below the opening portion 12b is also covered by the detection portions 31, 32.

To the substrate portion 33 corresponding to the one detection portion 31, a drive circuit 38 is mounted as an electric circuit component, the drive circuit 38 supplying alternating current to each coil 36. To the other detection portion 32, a detection circuit 39 is mounted as an electric circuit component, the detection circuit 39 detecting induced current or induced voltage generated in the coil 36. Hereinafter, the coil 36 of the one detection portion 31 is sometimes referred to as the transmitting-side coil 36, and the coil 36 of the other detection portion 32 is sometimes referred to as the receiving-side coil 36. The drive circuit 38 supplies alternating current to the transmitting-side coils 36 along with the direction X in series. Namely, by supplying current in series, with respect to the direction X, one end of transmitting-side coil 36 to the other end of transmitting-side coil 36, the travel surface 15 is scanned in the direction X. When the alternating current is supplied to the transmitting-side coil 36, electromagnetic coupling is generated at the cell portion 37 and induced current flows through the receiving-side coil 36. When the detected pieces 24 (see FIG. 5) are positioned on the detection units 31, 32, changed is a state of electromagnetic coupling of the cell portions 37 existing within a predetermined range the center of which is the detected piece 24. Thereby, with respect to the induced current or the induced voltage outputted from the receiving-side coil 36 (hereinafter, sometimes referred to as the output signal), the intensity is changed according to the distance up to the detected piece 24. By correlating each scanning position with respect to the direction X of each transmitting-side coil 36 and each position with respect to the direction Y of each receiving-side coil 36, it is possible to measure intensity distribution of output signal of each cell portion 37 on the travel surface 15. Further, it is possible to detect the position of the detected pieces 24 on the travel surface 15 based on the intensity distribution measured. The detected pieces 24 are provided to the self-propelling vehicle 7 having space therebetween with respect to the front-back direction. By specifying the detected pieces 24 of the same self-propelling vehicle 7 from the detection results of the detection circuit 39, it is possible to detect the position and direction on the travel surface 15 with respect to the self-propelling vehicle 7.

Next, the installation structure of the sensor 16 will be explained. The detection portion 31 including the transmitting-side coils 36 and the detection portion 32 including the receiving-side coils 36 are laid on all over the travel surface 15 by the same installation structure except vertical relation of them. Therefore, hereinafter, the installation structure will be described with respect to the transmitting side as an example. As shown in FIG. 7, the sensor 16 is configured in such a way that plural modules 30 are arranged side-by-side on the upper surface of section plate 14. Each module 30 is provided with the detection portion 31 and the substrate portion 33. The detection portion 31 provided to one module 30 is formed in the rectangular shape, the rectangular having an enough length to cross the upper surface of section plate 14 in the width direction thereof (the direction Yin FIG. 7). Incidentally, the coil 36 of the detection portion 31 is also extended in the longitudinal direction of the detection portion 31.

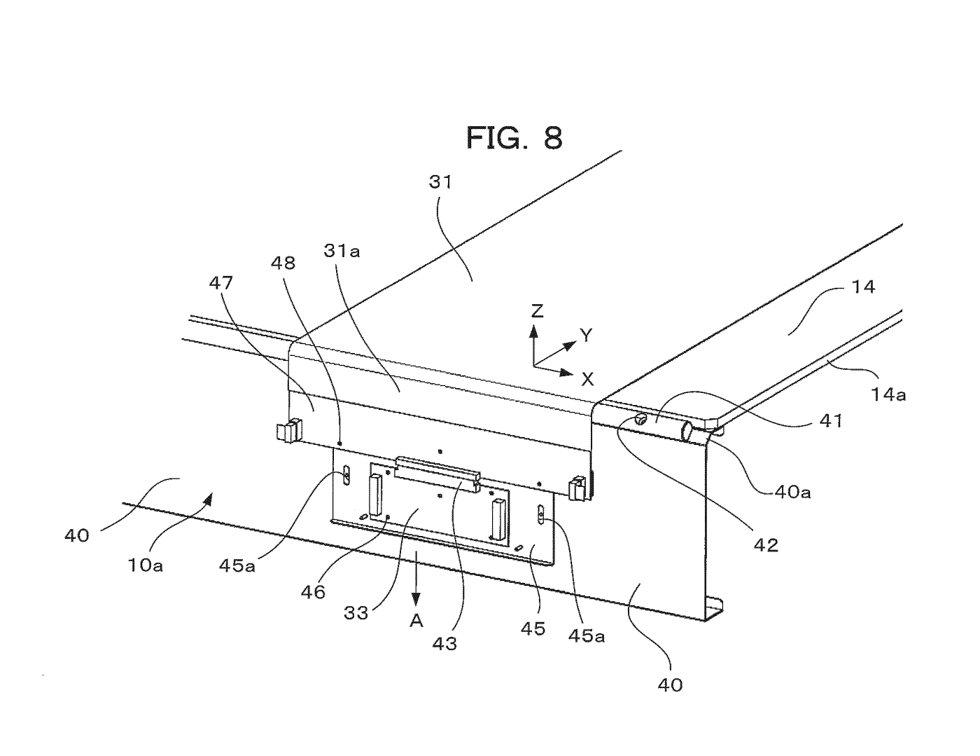

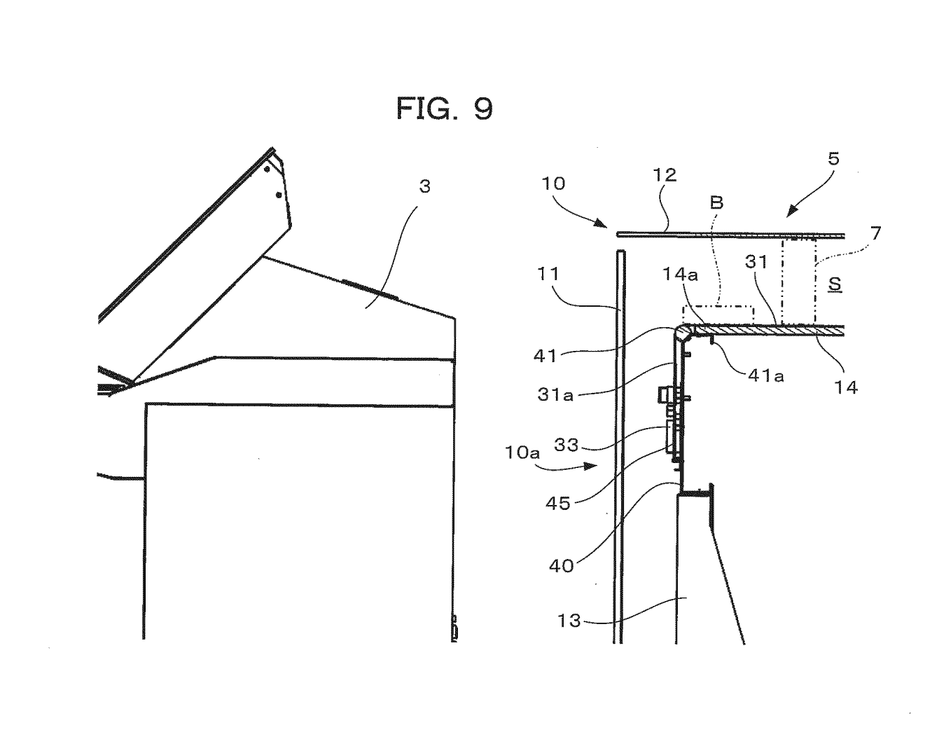

As described in detail in FIGS. 8 and 9, each metal plate 40 is attached to each side surface 10a of the chassis 10. The plate 40 is attached to the frame 13 so as to be arranged along a circumferential edge portion 14a of the section plate 14, and thereby, constitutes one portion of the chassis 10. As shown in FIG. 8, the section plate 14 is attached to the chassis 10 so that the circumferential edge portion 14a thereof overlaps a turndown portion 40a of each plate 40. On the turndown portion 40a of the plate 40, a guiding member 41 is provided so as to be located at the border between the circumferential edge portion 14a of the section plate 14 and the side plate 10a of the chassis 10, and the guiding member 41 is fixed by a bolt 42. The outer circumference of the guiding member 41 is formed in the rounded shape.

The end portion 31a of the detection portion 31 is bent toward the plate 40 side while wrapping the guiding member 41. The substrate portion 33 is connected with the bent end portion 31a of the detection portion 31 through the connector 43. While being physically connected with the base sheet 35 (see FIG. 6) of the detection portion 31 through the connector 43, the substrate portion 33 is electrically connected with each coil 36 of the detection portion 31 through the connector 43. Behind the substrate portion 33, provided is an attachment plate (an attachment member) 45 obtained by processing a metal plate. The substrate portion 33 is fixed to the surface of the attachment plate 45 using plural screws 46. To the end portion 31a of the detection portion 31, a metal subsidiary plate (a subsidiary member) 47 is provided so as to cover the base sheet 35. The subsidiary plate 47 is fixed to both of the attachment plate 45 and the detection portion 31 (more specifically, the base sheet 35) using plural screws 48. A pair of attachment holes 45a are formed in the attachment plate 45. Each of the attachment holes 45a has the long hole shape extending in a vertical direction. The attachment plate 45 is fixed to the chassis 10 by screwing un-illustrated attachment bolt in the plate 40 through each of the attachment holes 45a.

Although the illustration is omitted, the opposite end portion of the detection portion 31 is fixed to the chassis 10 by an appropriate attachment structure. For example, as with the end portion 31a of the substrate portion 33 side, the opposite end portion of the detection portion 31 is also bent toward the plate 40 side with wrapping the guiding member 41 and fixed to the plate 40 by using an attachment member similar to the subsidiary plate 47. Accordingly, by fixing the attachment plate 45 to the plate 40 in a state that a detection portion 31 is tensed with appropriate force generated by drawing the attachment plate 45 lower (the arrow A direction in FIG. 8), it is possible to put the detection portion 31 on the upper surface of the section plate 14 without slack. As the attachment plate 45 and the detection portion 31 are coupled with each other through the subsidiary plate 47, even if force is applied to the attachment plate 45, the force is never transmitted to the connector 43. Therefore, there is no possibility there could occur a trouble such as disconnection of the connector 43 caused by too much load at the moment of attaching the substrate portion 33.

As shown in FIG. 9, the substrate portion 33 attached to the plate 40 is concealed from the outside by the side plate 11 of the chassis 10. The station units 3 are arranged on a further outside of the side plate 11. The attachment position of the substrate portion 33 is set to a region which is included in the circumference of the chassis 10 and is covered by the station unit 3. Each station unit 3 is configured as a unit independent of the chassis 10 so as to separate from the chassis 10. Accordingly, if the station units 3 get removed from the chassis 10 and the side plates 11 get removed, it is possible to expose the substrate portions 33 along the circumference of the chassis 10. Thereby, it is possible to access easily to the substrate portion 33. As shown with an imaginary line B in FIG. 9, assumed that the substrate portions 33 are arranged so as to overlap the circumferential edge portion 14a of the section plate 14, it becomes not easy to access to the substrate portions 33 because of some obstacles such as the top plate 12. Moreover, as the space S is partially occluded by the substrate portions 33, the circumference of the space S existing between the top plate 12 and the section plate 14, that is, the entrance portion of the space S is narrowed. Thereby, an obstacle arises in the access to the inside of the space S. As apparent from FIG. 7, as the substrate portion 33 is provided to each of the plurality of modules 30, such inconvenience could occur at a lot of locations of the circumference of the chassis 10. On the other hand, as the self-propelling vehicle 7 has a height equal to the entire length of the space S, in a case the entrance portion is narrowed by the substrate portions 33, the self-propelling vehicle cannot be got out of and put into the space S in a upright state, and it is required to incline the self-propelling vehicle to the horizontal direction. However, it is hard to execute such an operation in the narrow space S. However, according to the present embodiment, as the substrate portions 33 exist on the side wall 10a, all inconveniences above mentioned are eliminated. Therefore, it is possible to significantly enhance work efficiency at the moment of maintenance of the game machine or the like.

Next, the correction of output signal of the sensor 16 will be described. As mentioned above, the sensor 16 detects the position of the detected body 24 of the self-propelling vehicle 7 by measuring the intensity distribution of output signal appropriate for the state of electromagnetic coupling of the cross portion of the coils 36 of the detection portions 31, 32, that is, the cell portion 37. However, at each cell portion 37 of the sensor 16, the state of electromagnetic coupling could change and the affection thereof appears in the output signal, not only because of the detected body 24, but also in a case an electric conductor exists around the cell portion 37. Around the section plate 14 of the chassis 10, some components made of electric conductor, such as the gate unit 8 and the plate 40, are arranged appropriately. Then, the affections of those components appear in the intensity distribution of output signal outputted by the sensor 16. Moreover, the affection is different depending on each game machine 1, or there is a possibility that the affection changes with time. Then, in order to improve the position detection accuracy of the self-propelling vehicle 7 by the sensor 16, required is the following processes of: measuring the intensity distribution of output signal in a state that the self-propelling vehicle 7 does not exist and storing the intensity distribution as correction data; and, in a case of detecting the position of the self-propelling vehicle 7, calculating an accurate intensity distribution by subtracting the correction data from the data of intensity distribution detected by the sensor 16 (this process is referred to as the correction process).

However, for removing the self-propelling vehicle 7, disassembly operation of the game machine 1 is necessary, and for generating the correction data, at least it is necessary to assemble the chassis 10 and all of the accessories thereof. The operation like this is troublesome. Then, with respect to the game machine 1, the mentioned inconvenience could be eliminated by generating the correction data without removing the self-propelling vehicle 7 as follows.

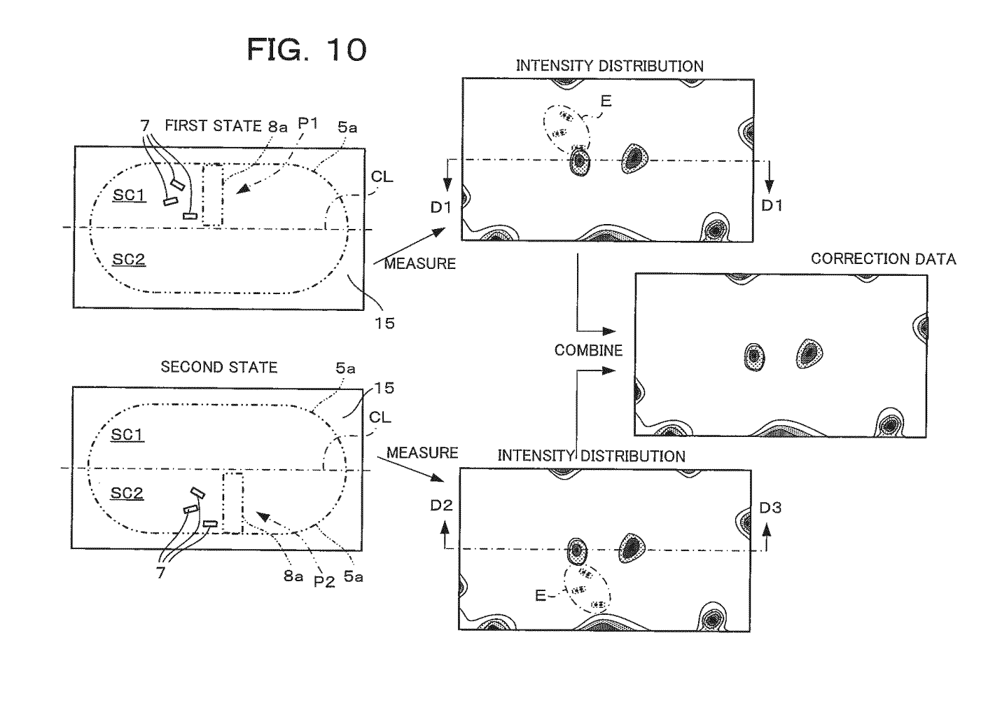

FIG. 10 shows a simple overview of procedures of generating the correction data in the game machine 1. In the game machine 1, in a case that the travel surface 15 is sectioned into the first region SC1 and the second region SC2 by a central line CL as a border line, the central line CL extending in the longitudinal direction of the course 5a, a first state that the self-propelling vehicles 7 gather in the first region SC1 and a second state that the self-propelling vehicles 7 gather in the second region SC2 selectively occur. For example, the first state occurs in a case that the gate 8a is controlled to be located at the position P1 for the start and all of the self-propelling vehicles 7 (FIG. 10 shows only 3 vehicles as an example) gather to house the models 6 into the gate 8a, and the second state occurs in a case that the gate 8a is controlled to be located at the position P2 and all of the self-propelling vehicles 7 gather to house the models 6 into the gate 8a. In the first state, no self-propelling vehicle 7 exists in the second region SC2, and in the second state, no self-propelling vehicle 7 exists in the first region SC1. Then, generated is the correction data relating to the intensity distribution of whole of the travel surface 15 by the following processes: the intensity distribution of output signal of the sensor 16 is measured in each of the first state and the second state; the intensity distribution of the second region SC2 which was measured in the first state (the distribution within a region shown by arrows D1-D1) and the intensity distribution of the first region SC1 which was measured in the second state (the distribution within a region shown by arrows D2-D2) are extracted; and the intensity distributions extracted are combined.

In FIG. 10, the intensity distribution is shown so that the higher the signal intensity is, the higher the color intensity is (the color verges to black). Here, with respect to height of the intensity, it is defined that as the cell portion 37 is closer to the electric conductor, the intensity becomes higher. With respect to the measurement in each of the first state and the second state, the intensity distribution obtained includes a portion indicating the intensity corresponding to the detected body 24 of the self-propelling vehicle 7, as shown by a region E. However, in the region to be used for the combination to generate the correction data, there is no portion corresponding to the detected body 24 of the self-propelling vehicle 7. Accordingly, the correction data that is the intensity distribution obtained after the combination is substantially equivalent to the intensity distribution of a case that all of the self-propelling vehicles 7 are removed from the travel surface 15 and the intensity is measured. Accordingly, when the correction data is subtracted from the data of signal intensity distribution of the sell portions 37 measured at the moment of detecting the position of the self-propelling vehicle 7, it is possible to detect accurately the position of the detected body 24 of the self-propelling vehicle.

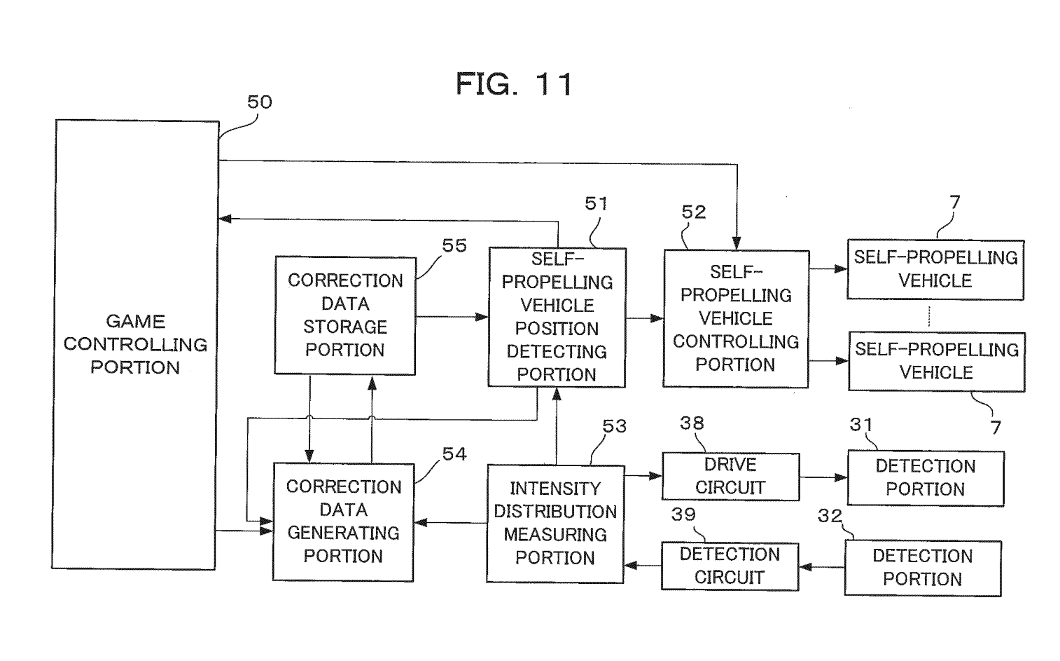

FIG. 11 is a functional block diagram showing a control system of the game machine 1 mainly with respect to a portion relating to the mentioned generation of the correction data. The control system 1 of the game machine 1 is provided with a game controlling portion 50, a self-propelling vehicle position detecting portion 51, a self-propelling vehicle controlling portion 52, an intensity distribution measuring portion 53, and a correction data generating portion 54. Each of the portions 51 to 54 is a logical device which is realized by a combination of a computer unit as hardware provided to the game machine 1 and a predetermined computer program as software. Further, the control system of the game machine 1 is provided with a correction data storage portion 55 storing the correction data relating to the intensity distribution of the sensor 16 mentioned.

The game controlling portion 50 executes calculation and operation control necessary for progress of a horse race game on the field 5. For example, the game controlling portion 50 calculates sequentially a target position and the like of each model 6 before a race, during a race, and after a race in accordance with a predetermined condition, and controls to switch the position of the gate unit 8 as necessary. The self-propelling vehicle position detecting portion 51 corrects intensity distribution based on intensity distribution data measured by the sensor 16 and the correction data stored in the correction data storage portion 55, and detects the current position of the self-propelling vehicle 7 based on the intensity distribution data corrected. The self-propelling vehicle controlling portion 52 calculates operation control parameters of a drive unit 28 (see FIG. 5) necessary to make each self-propelling vehicle 7 travel to a target position, such as driving speed and driving direction of the left and right wheels 26, based on a target position of each self-propelling vehicle 7 indicated sequentially from the game controlling portion 50 and the current position of each self-propelling vehicle 7 detected by the self-propelling position detecting portion 51 (hereinafter, sometimes referred to as the position information), and notifies each self-propelling vehicle 7 of the calculation result. The notification from the self-propelling vehicle controlling portion 52 to the self-propelling vehicle 7 is performed by using a wireless system as one example. The drive unit 28 of self-propelling vehicle 7 drives the wheels 26 in accordance with the parameters notified from the self-propelling vehicle controlling portion 52.

While instructing the drive circuit 38 of the sensor 16 to scan using the receiving-side coils 36, the intensity distribution measuring portion 53 obtains the output signal of each receiving-side coil 36 through the detection circuit 39, and correlates the scan position of the receiving-side coil 36 to the position of the receiving-side coil 36 to calculate the distribution of signal intensity of each cell portion 37. The intensity distribution measured by the intensity distribution measuring portion 53 is outputted to the correction data generating portion 54 as necessary, while being outputted sequentially to the self-propelling vehicle position detecting portion 51. The correction data generating portion 54 generates the correction data of the sensor 16 based on an instruction from the game controlling portion 50, and updates original correction data stored in the correction data storage portion 55 by the correction data obtained newly. For the correction process by the correction data generating portion 54, used are the measuring result by the intensity distribution measuring portion 53, the detection result by the self-propelling vehicle position detecting portion 51, and the correction data originally stored in the correction data storage portion 55.

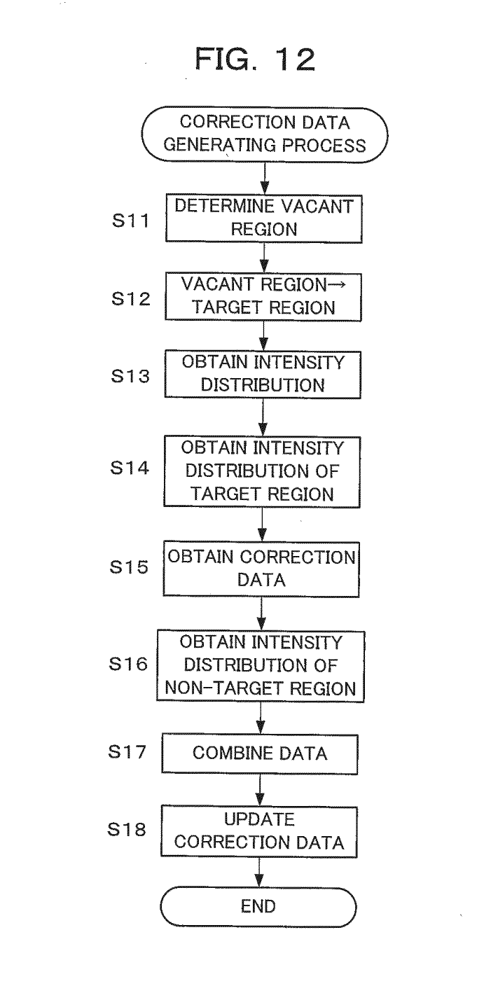

The correction data is generated by the correction data generating portion 54 at a time when, while the game controlling portion 50 is controlling the operation of self-propelling vehicle 7 for an aim other than an aim to generate of correction data, either the first state or the second state occurs as the control result. When either one of the states occurs, the game controlling portion 50 instructs the correction data generating portion 54 to generate the correction data. In response to the instruction, the correction data generating portion 54 starts correction data generating process shown in FIG. 12. Hereinafter, the procedure in the correction data generating process will be described.

When the correction data generating process is started, the correction data generating portion 54, first, determines whether either the region SC1 or the region SC2 on the travel surface 15 is a vacant region where no self-propelling vehicle 7 exists, based on the position information detected by the self-propelling vehicle position detecting portion 51 (step S11). Next, the correction data generating portion 54 sets the vacant region as a target region of process of this time (step S12), and subsequently, obtains the intensity distribution data from the intensity distribution measuring portion 53 (step S13). Further, the correction data generating portion 54 obtains from the intensity distribution data obtained from the intensity distribution measuring portion 53, the intensity distribution data of the target region, that is, the vacant region which is either one of the regions SC1 and SC2 (step S14). Subsequently, the correction data generating portion 54 obtains the correction data from the correction data storage portion 55 (step S15), and obtains from the correction data, the intensity distribution of non-target region, that is, the other one of the regions SC1 and SC2 (step S16). After that, the correction data generating portion 54 combines the intensity distribution data obtained at step S14 and the intensity distribution data obtained at step S16 to generate correction data (step S17), and by overwriting the correction data storage portion 55 by the correction data generated, updates the correction data in the storage portion 55 (step S18). After that, the correction data generating portion 54 ends the process of this time. By implementing the above process appropriately at an appropriate time when either the first region SC1 or the second region SC2 becomes the vacant region, the correction data stored in the correction data storage portion 55 is updated repeatedly. Thereby, it is possible to improve the position detection accuracy by the sensor 16.

In the above example, the correction data generating process is implemented in time with the chance that either the first state or the second state occurs while the game controlling portion 50 is controlling the progress of the game. However, the process shown in FIG. 12 may be implemented at an appropriate chance when either one of the first state and the second state occurs. For example, in the game machine 1, when remaining capacity of rechargeable battery built in the self-propelling vehicle 7 decreases up to a predetermined level, implemented is a control to make the self-propelling vehicle 7 travel up to the position of the electric charge unit 18 and to take a weak rechargeable battery into the electric charge unit 18 and charge up the rechargeable battery. In a case that such process is implemented only at one electric charge unit 18 of either one of the first region SC1 and the second region SC2 on the travel surface 15, the process shown in FIG. 12 may be implemented by setting the other region as the target region. Alternatively, by the game controlling portion 50 or the self-propelling vehicle control-ling portion 52, the operation of self-propelling vehicle 7 may be controlled intentionally so that either the first state or the second state occurs, and in liaison with this control, the process shown in FIG. 12 may be implemented.

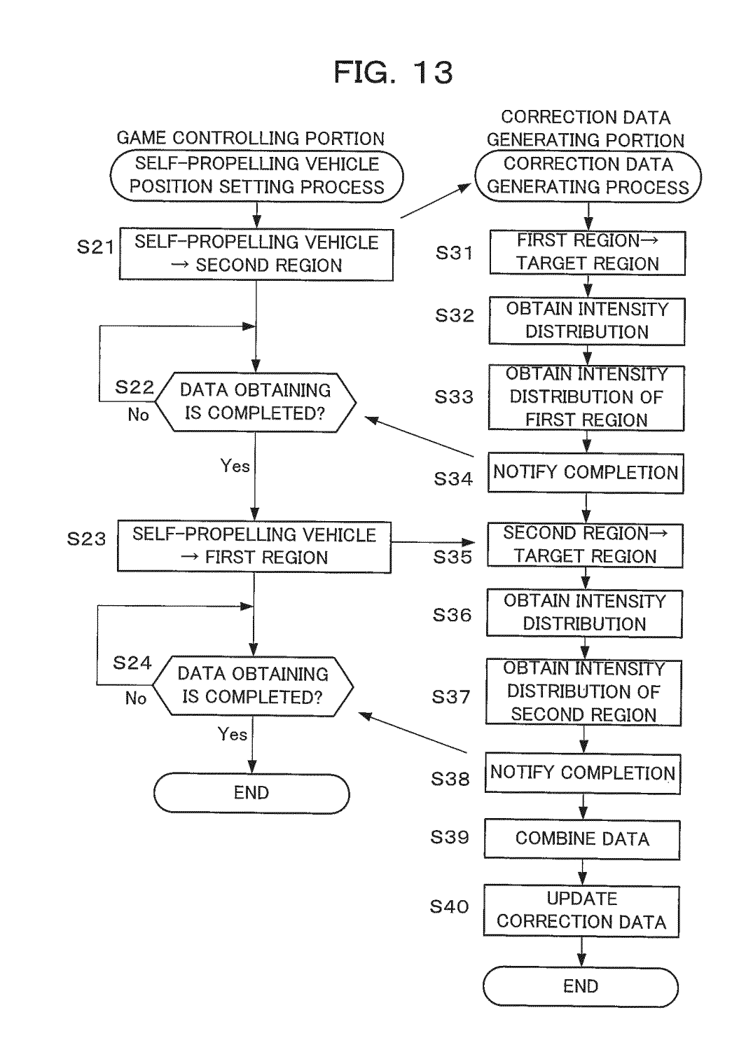

Further, by the game controlling portion 50 or the self-propelling controlling portion 52, the operation of self-propelling vehicle 7 may be controlled so that the first state or the second state occurs in series for an aim to generate the correction data, and the correction data may be generated by obtaining the intensity distribution data of each of the first region SC1 and the second region SC2 in series in time with occurrence of each state. FIG. 13 shows a process as one example of this case. In FIG. 13, applied is an example where the game controlling portion 50 implements a self-propelling vehicle position setting process for setting intentionally the position of self-propelling vehicle 7, and in liaison with this process, the correction data generating portion 54 implements the correction data generating process. However, the self-propelling vehicle position setting process can be implemented by the self-propelling vehicle controlling portion 52.

In the example of FIG. 13, the game controlling portion 50 starts the self-propelling vehicle position setting process when determining that there is no problem even if the position control of self-propelling vehicle 7 is implemented for an aim to generate the correction data. First, while instructing the self-propelling vehicle controlling portion 52 so that all of the self-propelling vehicles 7 gather in the second region SC2, the game controlling portion 50 instructs the correction data generating portion 54 to start the correction data generating process (step S21). Subsequently, it is determined whether a completion of data obtaining has been notified from the correction data generating portion 54 (step S22). When the completion is notified, while instructing the self-propelling vehicle controlling portion 52 so that all of the self-propelling vehicles 7 gather in the first region SC1, the game controlling portion 50 also notifies the instruction to the correction data generating portion 54 (step S23). Subsequently, the game controlling portion 50 determines whether a completion of data obtaining is notified from the correction data generating portion 54 (step S24). When the completion has been notified, the game controlling portion 50 ends the self-propelling vehicle position setting process.

While, the correction data generating portion 54 sets the first region SC1 to a target region of process (step S31). In this case, the process of step S31 is deferred or the process of step S32 is not started until it is confirmed that no self-propelling vehicle 7 exists in the first region SC1 based on the position information from the self-propelling position vehicle detecting portion 51. Next, the correction data generating portion 54 obtains intensity distribution data from the intensity distribution measuring portion 53 (step S32), and subsequently, from the intensity distribution data obtained, obtains intensity distribution data of the target region, that is, the first region SC1 (step S33). Next, the correction data generating portion 54 notifies the completion of data obtaining with respect to the first region SC1 to the game controlling portion 50 (step S34). After that, the correction data generating portion 54 sets the second region SC2 to a target region of process on the condition that the instruction of step S23 is transmitted from the game controlling portion 50 (step S35). In this case, the process of step S35 is deferred or the process of step S36 is not started until it is confirmed that no self-propelling vehicle 7 exists in the second region SC2 based on the position information from the self-propelling position detecting portion 51.

Next, the correction data generating portion 54 obtains the intensity distribution data from the intensity distribution measuring portion 53 (step S36), and subsequently, from the intensity distribution data obtained, obtains intensity distribution data of the target region, that is, the second region SC2 (step S37). After that, the correction data generating portion 54 notifies the completion of data obtaining with respect to the second region SC2 to the game controlling portion 50 (step S38). After that, the correction data generating portion 54 combines the intensity distribution data obtained at step S33 and the intensity distribution data obtained at step S37 to generate the correction data (step S39). By overwriting the correction data storage portion 55 by the correction data generated, the correction data generating portion 54 updates original correction data stored in the storage portion 55 (step S40). After that, the correction data generating portion 54 ends the correction data generating process of this time. In this way, the intensity distribution data of the first region SC1 and the intensity distribution data of the second region SC2 are obtained in series, and the correction data of whole of the travel surface is updated in a lump.

In the above embodiment, plural station units 3 are arranged around the chassis 10, the present invention does not always require the station units 3. The game machine to which the present invention is applied is not limited to an example of game machine which makes a model representing a racehorse travel on a filed. The model may be formed so as to represent a vehicle or other various kinds of shapes. The traveling body is not limited to an example of traveling body which travels on the upper surface of the section plate as the travel surface. A traveling body which travels in the space between the top plate and the section plate can be employed. Further, the game machine of the present invention is not limited to an example of game machine which comprises the model traveling on the top plate by following the traveling body. For example, the present invention can be applied to a game machine where one portion or whole of a transparent top plate is provided so that travel of traveling body is observed through the top plate. In a case that a sensor has a construction that a substrate portion is connected to an end portion of a sheet-like detection portion, the sensor can be employed, and the detection method thereof is not limited to a method using electromagnetic coupling.

What is claim is:

1. A game machine comprising:
a chasses having a top plate and a section plate arranged at a lower surface side of the top plate to make space;
a traveling body arranged in the space and capable of traveling along an upper surface of the section plate; and
a sensor outputting signal corresponding to a position of the traveling body, the sensor having
a detection portion that is laid on the upper surface of the section plate and has a flexibility and a sheet shape and
a substrate portion being provided with an electric circuit component necessary for detecting the position using the detection portion and connected with an end portion of the detection portion,
wherein
the end portion of the detection portion of the sensor is bent along a side surface of the chassis from a circumferential edge portion of the section plate, and the substrate portion is attached to the chassis at the side surface.

2. The game machine according to claim 1, wherein
a guiding member an outer circumference of which is rounded is attached to a border between the circumferential edge portion of the section plate and the side surface of the chassis, and the detection portion is bent so as to wrap the guiding member.

3. The game machine according to claim 1, wherein
a position where the substrate portion is attached to the chasses is capable of been adjusted in a vertical direction.

4. The game machine according to claim 3, wherein
the substrate portion is attached to the chassis through an attachment member,
a position where the attachment position is attached is capable of being adjusted in the vertical direction, and
the attachment member is coupled with the end portion of the detection portion through a subsidiary member.

5. The game machine according to claim 1, wherein
the sensor is configured in such a way that a plurality of modules are aligned side-by-side on the upper surface of the section plate, and each of the plurality of modules is provided with the detection portion and the substrate portion.

6. The game machine according to claim 1, wherein
a plurality of station units, each of which allows a player to play a game, are arranged around the chasses in separable state from the chassis, and the position where the substrate portion is attached to the chassis is set in a region covered by the station units.
